(19) United States
(12) Patent Application Publication
(10) Pub. No.: US 2003/0211390 A1
(43) Pub. Date: Nov. 13, 2003

(54) Grain boundary materials as electrodes for lithium ion cells

(76) Inventors: Jeffrey R. Dahn, Nova Scotia (CA); Luc Y.J. Beaulieu, Nova Scotia (CA); Dominique C. Larcher, Cedex (FR); Brian D. Fredericksen, Watertown, MN (US)

Correspondence Address: Lucy C Weiss, Office of Intellectual Property Counsel, 3M Innovative Properties Company, PO Box 33427, St Paul, MN, 55133-3427, US

(21) Appl. No.: 10/169,226

(22) PCT Filed: Dec. 22, 2000
(86) PCT No.: PCT/US00/35331

(51) Int. Cl. H01M 4/38; H01M 4/46; H01M 4/42; H01M 4/58

(52) U.S. Cl. 429/218.1; 429/229; 429/231.6; 429/224; 429/231.5; 429/221; 429/220; 429/231.8; 429/231.95

(57) ABSTRACT

An electrode composition for a lithium ion battery comprising particles having a single chemical composition. The particles consist of (a) at least one metal element selected from the group consisting of tin, aluminum, silicon, antimony, lead, germanium, magnesium, zinc, cadmium, bismuth, and indium; (b) at least one metal element selected from the group consisting of manganese, molybdenum, niobium, tungsten, tantalum, iron, copper, titanium, vanadium, chromium, nickel, cobalt, zirconium, tantalum, scandium, yttrium, ruthenium, platinum, and rhenium; and, optionally, (c) carbon, and have a microstructure characterized by a plurality of electrochemically inactive, nanometer-sized crystalline grains separated by electrochemically active non-crystalline regions.

### STATEMENT OF PRIORITY

This application derives priority from a provisional application filed Dec. 28, 1999, entitled “Grain Boundary Materials as Anodes for Lithium Ion Cells” bearing serial No. 60/173364, the contents of which are hereby incorporated by reference.

### TECHNICAL FIELD

This invention relates to anode compositions useful in lithium ion cells.

### BACKGROUND

Two classes of materials have been proposed as anodes for lithium ion cells. One class includes materials such as graphite and carbon that are capable of intercalating lithium. While the intercalation anodes generally exhibit good cycle life and coulombic efficiency, their capacity is relatively low. In particular, graphite can intercalate lithium to a maximum of 1 lithium atom per six carbon atoms. This corresponds to a specific capacity of 373 mAh/g of carbon. Because the density of graphite is 2.2 g/cc, this translates to a volumetric capacity of 818 mAh/cc. Other types of carbon have higher specific capacity values, but suffer from one or more disadvantages such as relatively low density, unattractive voltage profiles, and large irreversible capacity that limit their utility in commercial lithium ion cells.

A second class includes metals that alloy with lithium metal. These alloy-type anodes generally exhibit higher capacities relative to intercalation-type anodes. For example, specific capacity associated with the formation of a lithium-aluminum alloy is 992 mAh/g. The corresponding value for the formation of a lithium-tin alloy is 991 mAh/g. One problem with such alloys, however, is that they can exhibit relatively poor cycle life and coulombic efficiency due to fragmentation of the alloy particles during the expansion and contraction associated with compositional changes in the alloy.

### SUMMARY

The invention provides electrode compositions suitable for use in lithium ion batteries in which the electrode compositions have high initial capacities that are retained even after repeated cycling. The electrode compositions, and batteries incorporating these compositions, are also readily manufactured.

To achieve these objectives, the invention features, in a first aspect, an electrode composition that includes particles having a single chemical composition formed from (a) at least one metal element selected from the group consisting of tin, aluminum, silicon, antimony, lead, germanium, magnesium, zinc, cadmium, bismuth, and indium; (b) at least one metal element selected from the group consisting of manganese, molybdenum, niobium, tungsten, tantalum, iron, copper, titanium, vanadium, chromium, nickel, cobalt, zirconium, tantalum, scandium, yttrium, ruthenium, platinum, and rhenium; and, optionally, (c) carbon. The particles have a microstructure characterized by a plurality of electrochemically inactive, nanometer-sized crystalline grains separated by electrochemically active non-crystalline regions.

As used herein, a “particle” is a component of a powder. Each particle is made up of many crystalline “grains.” A crystalline grain is a region of the particle from which diffraction occurs coherently (i.e., the crystal axes have fixed directions within the grain). The crystalline grains are separated by non-crystalline regions. These regions are characterized by a lower degree of order compared to the crystalline grains.

A “single chemical composition” means that when the sample is analyzed by transmission electron microscopy, the types of atoms that are detected are the same, on a nanometer scale range, regardless of where the electron beam is placed within the sample.

An “electrochemically active” material is a material that reacts with lithium under conditions typically encountered during charging and discharging in a lithium battery.

An “electrochemically inactive” material is a material that does not react with lithium under conditions typically encountered during charging and discharging in a lithium battery.

Examples of useful particles include those characterized by the chemical composition SnMn₃C and SnFe₃C. These materials have electrochemically inactive crystalline grains, yet form useful electrode materials owing to the presence of electrochemically active tin atoms in the non-crystalline regions separating the crystalline grains. Preferably, the particles have a size ranging from about 2 microns to about 30 microns (measured by scanning electron microscopy). The crystalline grains preferably are no greater than about 20 nanometers where this figure refers to the length of the longest dimension of the grain. The non-crystalline regions preferably from at least about 10% by volume of the particle, calculated from transmission electron microscopy data assuming spherical grains.

The details of one or more embodiments of the invention are set forth in the accompanying drawings and the description below. Other features, objects, and advantages of the invention will be apparent from the description and drawings, and from the claims.

### DESCRIPTION OF DRAWINGS

FIG. 1 is an x-ray diffraction profile for a SnMn₃C sample prepared by ball milling for 20 hours. All observed diffraction peaks are from SnMn₃C.

FIG. 2 is an x-ray diffraction profile for a SnFe₃C sample prepared by ball milling for 20 hours. All observed diffraction peaks are from SnFe₃C.

FIG. 3 illustrates the cycling performance, in terms of voltage versus capacity and capacity versus cycle number, for two Li/SnMn₃C cells.

FIG. 4 illustrates the cycling performance, in terms of differential capacity versus voltage, for a Li/SnMn₃C cell.

FIG. 5 is a series of x-ray diffraction profiles for a Li/SnMn₃C cell obtained during discharge.

FIG. 6 is a series of Mössbauer spectroscopy scans for a Li/SnMn₃C cell obtained during discharge.

FIG. 7 illustrates the variation of the Mössbauer center shift of the minority component of a Li/SnMn₃C cell during charge and discharge.

FIG. 8 is a series of x-ray diffraction profiles for both an unheated SnMn₃C sample and for samples heated to 400° C., 500° C., and 600° C.

FIG. 9 illustrates the cycling performance, in terms of voltage versus capacity and capacity versus cycle number, for cells constructed using the samples described in FIG. 8.

FIG. 10 includes a series of x-ray diffraction profiles for both an unheated SnFe₃C sample and for samples heated to 100° C., 200° C., and 300° C., and further illustrates the cycling performance, in terms of voltage versus capacity, for cells constructed using these materials.

FIG. 11 includes a series of x-ray diffraction profiles for both an unheated SnFe₃C sample and for samples heated to 400° C., 500° C., and 600° C., and further illustrates the cycling performance, in terms of voltage versus capacity, for cells constructed using these materials.

FIGS. 12 and 13 are transmission electron micrographs of a SnMn₃C sample.

### DETAILED DESCRIPTION

The electrode compositions are in the form of powders made up of particles. The particles have the chemical composition and microstructure described in the Summary of the Invention, above. The powders may be prepared directly using techniques such as ball-milling. Alternatively, the powders may be prepared in the form of thin films using techniques such as sputtering, chemical vapor deposition, vacuum deposition, vacuum evaporation, melt spinning, splat cooling, spray atomization, and the like, and then pulverized to form powders.

The electrode compositions are particularly useful as anodes for lithium ion batteries. To prepare a battery, the electrode powder is combined with a binder (e.g., a polyvinylidene fluoride binder) and solvent to form a slurry which is then coated onto a backing using conventional coating techniques and dried to form the anode. The anode is then combined with an electrolyte and a cathode (the counterelectrode). The electrolyte may be a solid or liquid electrolyte. Examples of solid electrolytes include polymeric electrolytes such as polyethylene oxide, polytetrafluoroethylene, fluorine-containing copolymers, and combinations thereof. Examples of liquid electrolytes include ethylene carbonate, diethyl carbonate, propylene carbonate, and combinations thereof. The electrolyte is provided with a lithium electrolyte salt. Examples of suitable salts include LiPF₆, LiBF₄, and LiClO₄.

Examples of suitable cathode compositions for liquid electrolyte-containing batteries include LiCoO₂, LiCo_{0.2}NiO₂, and Li_{1.07}Mn_{1.93}O₄. Examples of suitable cathode compositions for solid electrolyte-containing batteries include LiV₃O₈ and LiV₂O₅.

The invention will now be described further by way of the following examples.

### EXAMPLES

Ball Milling Procedure

A Spex 8000 high-impact mixer mill was used to violently shake sealed, hardened steel vials for periods up to about 40 hours. In an argon-filled glove box, the desired amounts of elemental powders or intermetallic phases were added to the vial, along with several hardened steel balls measuring 12.7 mm in diameter. The vial was then sealed and transferred to the mill where it was shaken violently. The milling time was selected to be sufficient to reach milling equilibrium. In general, milling times were on the order of about 16 hours.

Cycling Behavior

Electrodes were prepared by coating slurries of the powders onto a copper foil and then evaporating the carrier solvent. In a typical preparation, about 82% by weight powder (prepared by ball milling), 10% by weight Super S carbon black (MMM carbon, Belgium), and 8% by weight polyvinylidene fluoride (Atochem) were thoroughly mixed with N-methyl pyrrolidinone by stirring in a sealed bottle to make a slurry; the polyvinylidene fluoride was pre-dissolved in the N-methyl pyrrolidinone prior to addition of the powder and carbon black. The slurry was spread in a thin layer (about 150 micrometers thick) on the copper foil with a doctor-blade spreader. The sample was then placed in a muffle oven maintained at 105° C. to evaporate the N-methyl pyrrolidinone over a 3 hour period.

Circular electrodes measuring 1 cm in diameter were cut from the dried film using an electrode punch. The electrodes were weighed, after which the weight of the copper was subtracted and the active mass of the electrode calculated (i.e., the total weight of the electrode multiplied by the fraction of the electrode made of the active electrode powder). The circular electrodes were then heat-sealed in polyethylene bags until further use.

The electrodes were used to prepare coin cells for testing. All cell construction and sealing was done in an argon-filled glove box. A lithium foil having a thickness of 125 micrometers functioned as the anode and reference electrode. The cell featured 2325 hardware, equipped with a spacer plate (304 stainless steel), and a disc spring (mild steel). The disc spring was selected so that a pressure of about 15 bar would be applied to each of the cell electrodes when the cell was crimped closed. The separator was a Celgard #2502 microporous polypropylene film (Hoechst-Celanese) that had been wetted with a 1 M solution of LiPF₆ dissolved in a 30:70 volume mixture of ethylene carbonate and diethyl carbonate (Mitsubishi Chemical).

After construction, the cells were removed from the glove box and cycle tested using a MACCOR constant current cycler. Cycling conditions were typically set at a constant current of 37 mA/g of active material. Cutoff voltages of 0.0 V and 1.3 V were used.

X-Ray Diffraction

Powder x-ray diffraction patterns were collected using a Siemens D5000 diffractometer equipped with a copper target x-ray tube and a diffracted beam monochromator. Data was collected between scattering angles of 10 degrees and 80 degrees unless otherwise noted.

To examine the electrode materials during cycling, in-situ x-ray diffraction experiments were performed. Cells for in-situ x-ray diffraction were assembled as described above in the case of the cycling experiment with the following differences. The coin cell can was provided with a circular hole measuring 18 mm in diameter. A 21 mm diameter beryllium window (thickness=250 micrometers) was affixed to the inside of the hole using a pressure sensitive adhesive (Roscobond from Rosco of Port Chester, N.Y.). The electrode material was coated directly onto the window before it was attached to the can.

The cell was mounted in a Siemens D5000 diffractometer and slowly discharged and charged while x-ray diffraction scans were taken continuously. Typically, a complete scan took 2-5 hours and the discharge and charge time took 40-60 hours, giving approximately 10-30 “snapshots” of the crystal structure of the electrode as a function of its state of charge. The voltage of the cell was continuously monitored during cycling.

Mössbauer Spectroscopy

In-situ ^{119 m}Sn Mössbauer spectroscopy was used to study the local environment of tin atoms during reaction with lithium. The advantage of Mössbauer spectroscopy is that it can distinguish between tin atoms within the non-crystalline regions and tin atoms within the crystalline grains.

Room temperature Mössbauer measurements were made with a Wissel System II constant acceleration spectrometer operating at a frequency of 23 Hz and a krypton/CO₂ x-ray proportional counter (Reuter-Stokes Inc.). The detector employed a Pd filter. Data were collected using an Ortec ACE multi-channel scaling board. The Ca^{119 m}SnO₃ source had an intrinsic line width of 0.78 mm/s (FWHM), and the velocity scale was calibrated using a mixed sample of tin and BaSnO₃. Elevated temperature measurements were made using a small heater placed around the sample without blocking the gamma rays.

Powder samples were prepared as follows. Powders were manually ground and sieved (−325 mesh). Typically, 150 mg of powder was uniformly distributed over a 30 mm piece of Scotch Brand adhesive tape (3M Co., St. Paul, Minn.), and was kept in place by another piece of tape on top. Total measurement times ranged between 3 and 24 hours.

The cell used for in-situ Mössbauer measurements was similar to the cell used for in-situ x-ray spectroscopy except that it was designed for maximum transmission of gamma rays. As such, all steel parts were removed (including the spacer and spring), and a second hole (diameter=13 mm) was cut in the cell top. A second piece of beryllium (diameter=15 mm, thickness=1 mm) was placed over the hold and held in place by Roscobond pressure sensitive adhesive. A thin bead of Torr Seal (high vacuum grade available from Varian) was applied following cell assembly at the interface between the cell bottom and beryllium piece, and at the interface between the cell top and beryllium piece. Electrodes, prepared as described above, were coated directly onto the beryllium.

The cell was held in place approximately 10 cm from the detector and 1 cm from the source. Charging and discharging currents were controlled by a Keithley 220 programmable current source interfaced to a computer equipped with a general purpose interface bus. Voltages were measured using a Keithley 196 digital voltmeter. Spectra were obtained continuously while the cell was discharged and subsequently charged. The total experiment time was approximately 180 hours, during which about 60 three-hour Mössbauer spectra were recorded. The spectra were fitted with one or more Lorentzian-shaped peaks. The center shift, area, and half-width of the fitted peaks were monitored.

Transmission Electron Microscopy

Samples were prepared for transmission electron microscopy by dispersing the powder in methanol and sonicating the dispersion for one minute. Next, one drop of the sonicated dispersion was placed on a standard 3 mm transmission electron microscopy grid (carbon/formvar thin film supported on a copper mesh grid). Excess solution was wicked away with a wedge of filter paper and the remaining sample was allowed to dry for 10 minutes before inserting it into the microscope.

Transmission electron microscopy and electron diffraction analysis were performed on a Hitachi H9000 instrument operating at 300 kV. Energy dispersive x-ray spectroscopy was performed on the same instrument using a Noran Voyager X-Ray Spectroscopy System.

Specific samples were prepared and tested as follows.

### Example 1

An intermetallic compound, SnMn₃C, was prepared by adding stoichiometric ratios of 0.800 g tin powder (Aldrich Chemical), 1.111 g manganese powder (Aldrich Chemical), and 0.081 g graphite powder (mesocarbon microbeads from Osaka Gas Ltd. that had been heated to 2650° C.), along with two 12.7 mm diameter hardened steel balls, to a hardened steel vial in an argon-filled glove box. The vial was placed in the Spex 8000 mixer and subjected to maximum milling intensity for 20 hours following the general procedure described above.

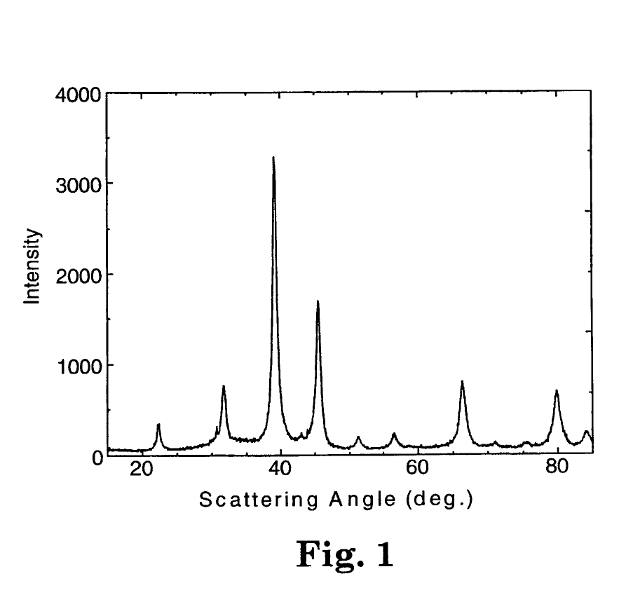

The x-ray diffraction pattern of the milled sample is shown in FIG. 1. It agrees with the literature pattern for SnMn₃C except that the Bragg peaks are broad (width=about 1 degree), indicating the presence of nanometer-sized grains. Using the Scherer formula, L=0.9λ/(Bcosθ), where L is the grain size, λ is the x-ray wavelength (1.54178 Å), B is the full width at half maximum of a particular x-ray peak in radians, and θ is the Bragg angle of the peak, the grain size is calculated to be about 8 nanometers. The particle size of the sample was in the range of 2-50 micrometers, determined by scanning electron microscopy, demonstrating that each particle was made up of many grains.

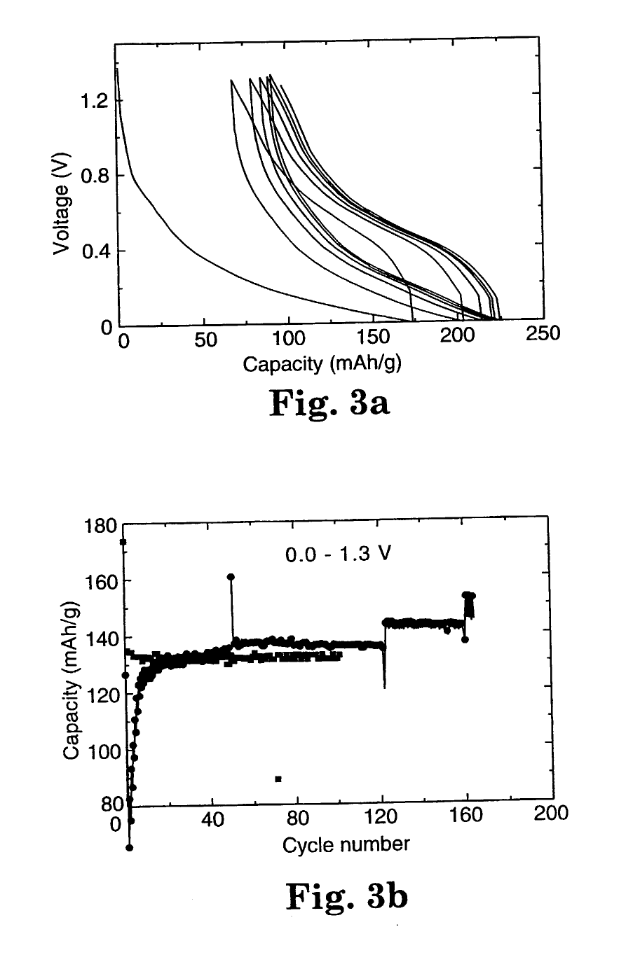

An electrochemical cell was constructed as described above and its cycling behavior tested. FIG. 3a shows the voltage-capacity for the cell. The cell exhibited a reversible capacity of about 130 mAh/g.

FIG. 3b shows the capacity versus cycle number for the cell depicted in FIG. 3a, and for an identical cell. Both show no loss in capacity over 100 cycles. One of the cells was slowed to 18.5 mA/g at cycle 120, and to 9 mA/g at cycle 160. At the lowest current, a capacity of 150 mAh/g was observed. This corresponds to a volumetric capacity of about 1200 mAh/g (calculated based upon a density value of 7.9 g/cc for SnMn₃C.

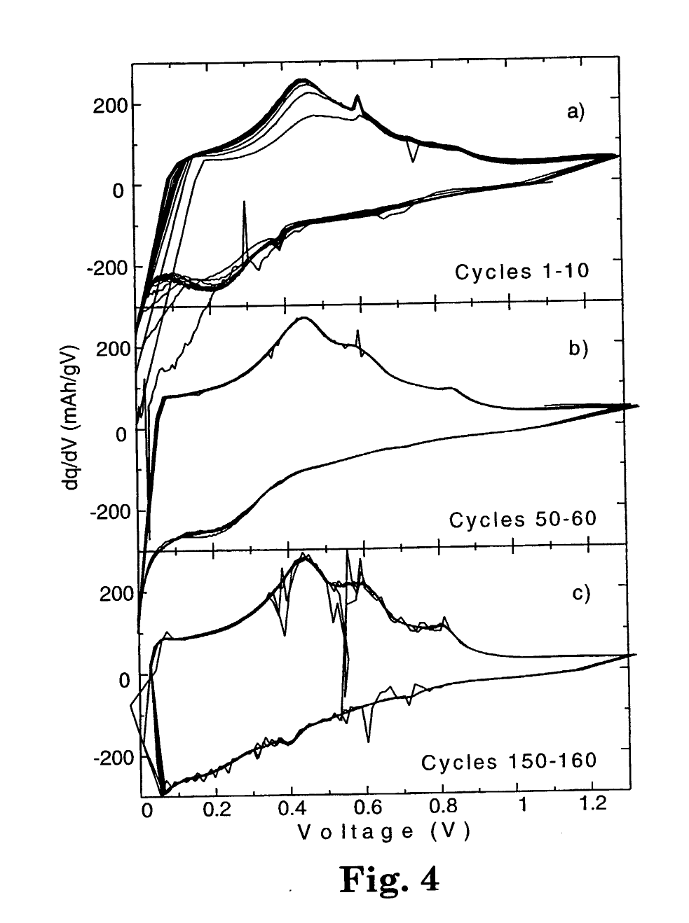

FIG. 4 shows the differential capacity versus voltage at several cycle numbers for the cell that was slowed. The differential capacity shows a stable pattern over the first 150 cycles, characteristic of nanometer-sized tin grains in a matrix. No sharp peaks in differential capacity develop, indicating that there is no aggregation of tin into large regions and that the tin atoms are active. If all the tin atoms were active, and each could react with 4.4 Li/Sn, then the specific capacity of SnMn₃C would be about 400 mAh/g. The observed value of 150 mAh/g corresponds to about 1.5 Li/Sn.

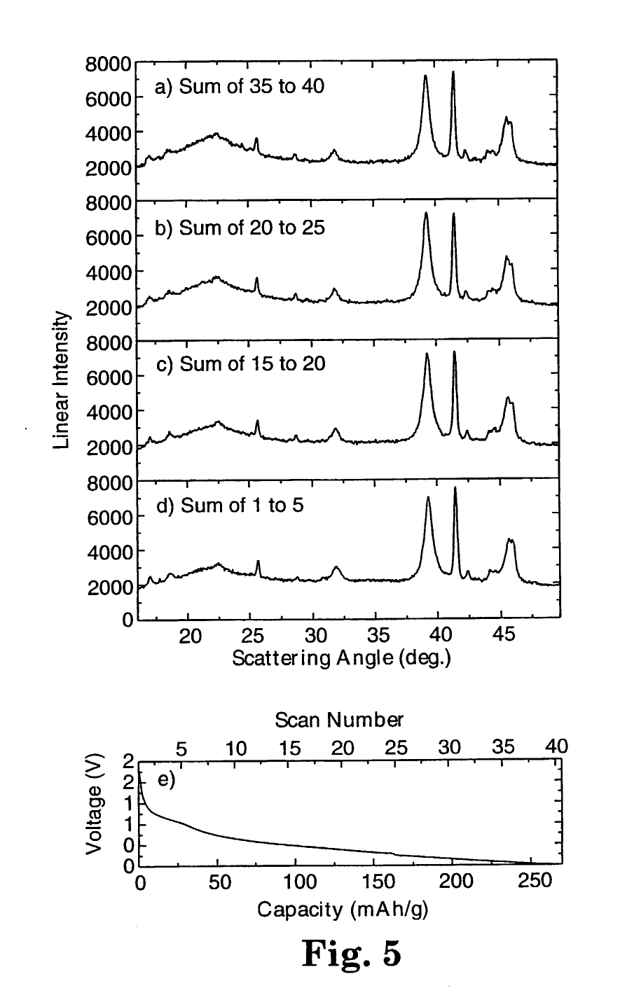

In-situ x-ray diffraction measurements were made using a specific current of 2.2 mA/g. X-ray scans of 3 hours duration were taken successively. FIGS. 5(a)-(d) show the x-ray diffraction pattern from the electrode during discharge; FIG. 5(e) shows voltage versus capacity (bottom axis) and versus scan number (top axis) for the sample. Each diffraction pattern represents the sum of five adjacent x-ray scans to improve the signal to noise ratio. The x-ray data demonstrate that even though approximately 2 Li/Sn have reacted with the electrode (calculated coulombmetrically based on the current, electrode mass, and time of current flow), there is no change in the position or intensity of the main Bragg peaks attributed to SnMn₃C at 32, 39, and 40°. On the other hand, the broad “hump” near 22° intensifies as the discharge process proceeds.

The fact that the Bragg peaks do not change is evidence that the nanocrystalline grains do not react with lithium at all. Accordingly, the only materials available to react with lithium are the tin atoms located in non-crystalline regions separating the grains. The intensification of the “hump” near 22° may be the result of small amounts (e.g., on the order of a few atoms) of Li₄Sn in the non-crystalline regions.

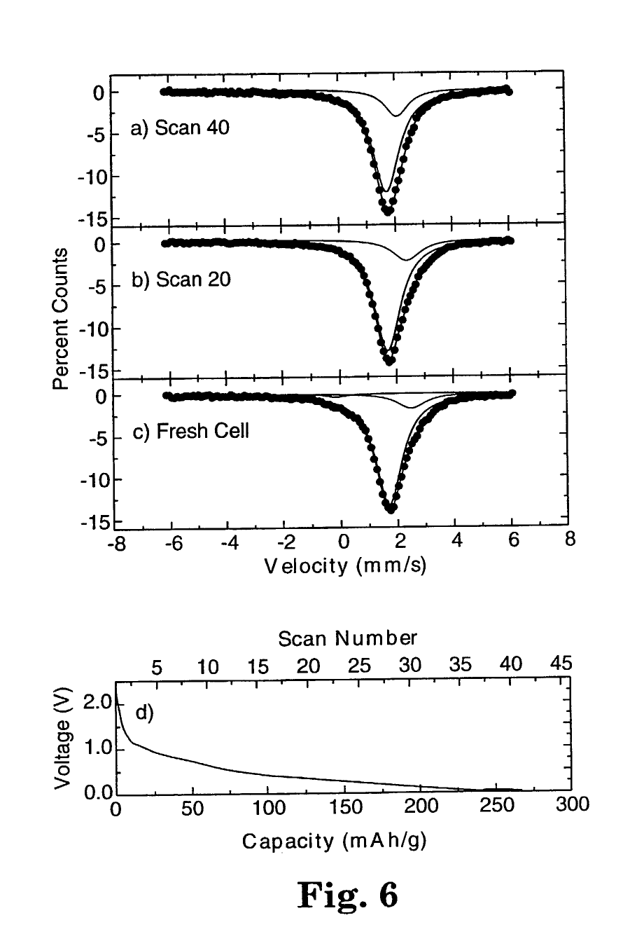

In-situ Mössbauer spectroscopy measurements were made using a discharge current of 2.2 mA/g following the procedure described above. Spectra of 3 hours duration were collected continuously. FIGS. 6(a), (b), and (c) show the first, twentieth, and fortieth scans. FIG. 6(d) shows voltage versus capacity (bottom axis) and versus scan number (top axis) for the sample. The first spectrum (FIG. 6(a)) was fitted with a major component with a center shift near 1.7 mm/s and a minor component with a center shift near 2.5 mm/s. A third component with a center shift near 0.0 mm/s was also included, but it was not needed in order to obtain a good fit. Because x-ray diffraction data showed that the nanometer-sized crystalline grains did not react with lithium, the center shift and half-width of the major component were kept fixed while fitting the spectra taken as the discharge proceeded.

FIGS. 6(b) and (c) show that the minor component shifts to smaller velocity as lithium reacts with the sample. The Mössbauer spectra demonstrate that the average center shift changes from about 2.5 to about 1.8 as lithium reacts with tin. Accordingly, the shift of the minor component is consistent with the reaction of lithium with tin.

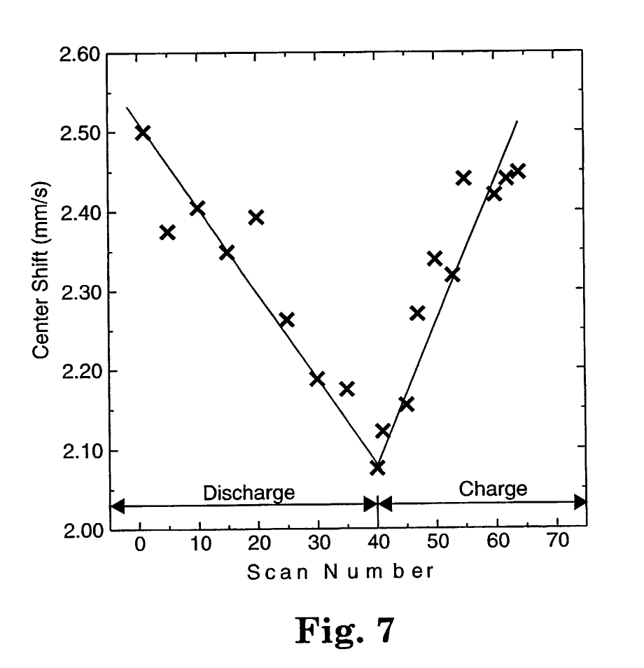

FIG. 7 shows the variation of the center shift of the minor component as a function of scan number taken during discharge and charge. The current used during charge was 3.3 mA/g. The change in the center shift is reversible. This is evidence for the reversible reaction of lithium with tin atoms located within the non-crystalline regions of the sample.

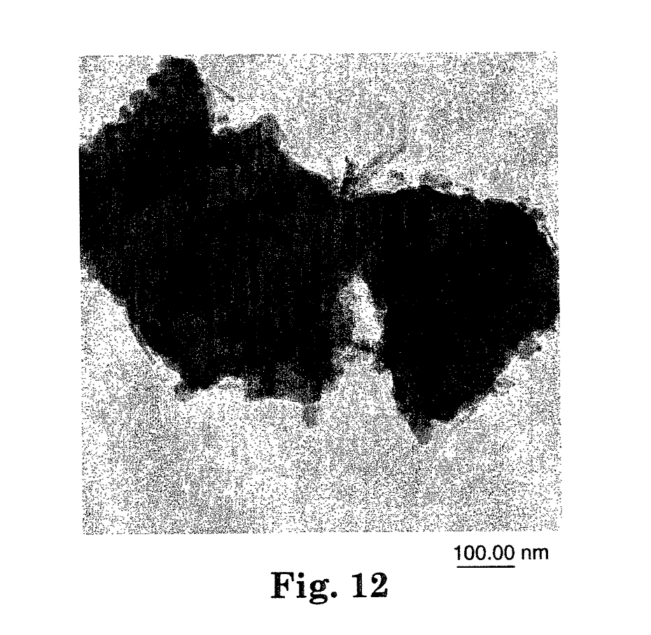

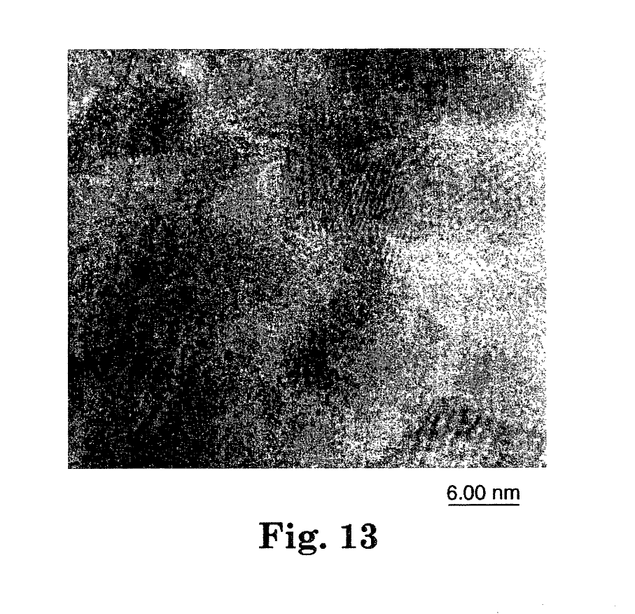

FIGS. 12 and 13 are transmission electron micrographs taken of the sample at both high (400,000×) and low (20,000×) magnification. The micrographs show the presence of two types of particles. The first type ranges in size from 10 nm to over 10 microns. These particles are composed of crystalline grains having a size in the 8 nanometer range. The grains are separated from each other by non-crystalline regions that are significantly less ordered than the crystalline grains. The scanned area exhibited a single diffraction pattern The second type of particle is a single crystal roughly on the order of 10-30 nanometers by 100-300 nanometers with a large aspect ratio (somewhere between 10:1 and 20:1).

### Example 2

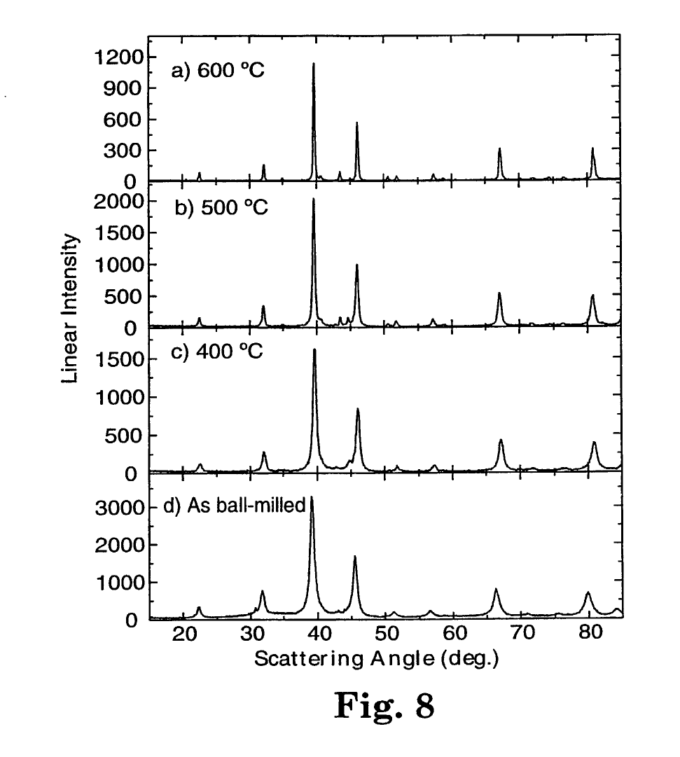

Three additional samples of SnMn₃C were prepared following the procedure of Example 1. The samples were heat-treated at 400° C., 500° C., and 600° C., respectively, under vacuum for 3 hours. The x-ray diffraction spectra for the three samples, as well as the sample from Example 1 prepared without heat-treating, are shown in FIG. 8. As shown in FIG. 8, the widths of the Bragg peaks of the SnMn₃C phase narrow as the temperature increases, consistent with a growth of the size of the nanometer-sized crystalline grains and a reduction in the number of atoms in the non-crystalline regions. FIG. 8 also shows evidence of some minor impurities, representing Fe—C phases, formed during heating as a result of iron contamination during milling.

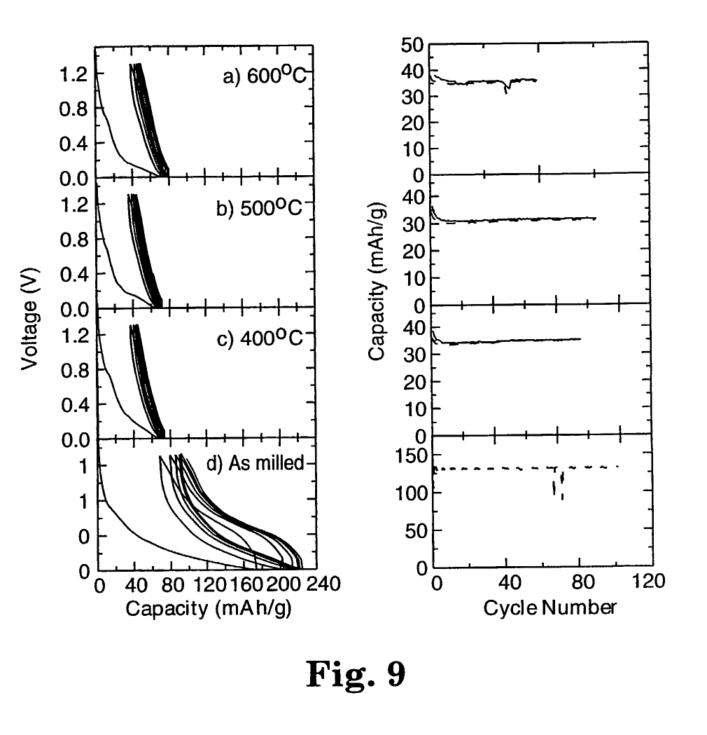

FIG. 9 shows the voltage versus capacity and capacity versus cycle number results for cells made from these samples. The cells containing heat-treated material show much smaller capacity compared to the cell containing unheat-treated material, of which about 15 mAh/g originates from the Super S carbon black used to prepare the electrode composition. These results are further evidence that heat treatment induces grain growth, thereby decreasing the size of the non-crystalline regions and reducing the reversible capacity of the materials. The reduction in capacity, in turn, is related to a decrease in the number of tin atoms in the non-crystalline regions available for reaction with lithium.

### Example 3

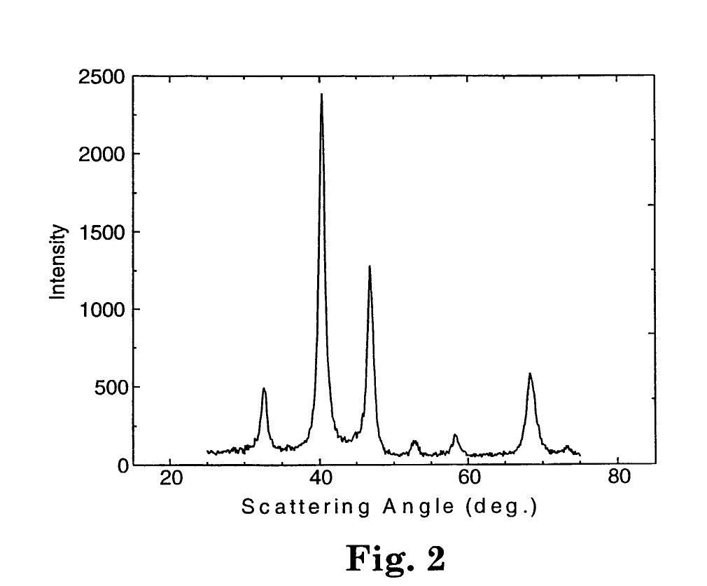

The procedure of Example 1 was followed except that 0.823 g tin powder, 1.160 g iron powder (Aldrich Chemical Co.), and 0.084 g graphite powder were used to prepare a material having the formula SnFe₃C. The x-ray diffraction pattern of the material is shown in FIG. 2. It agrees with the literature pattern for SnFe₃C except that the Bragg peaks are broad, indicating the presence of nanometer-sized grains. The particle size of the sample was in the range of 2-50 micrometers, determined using scanning electron microscopy, demonstrating that each particle was made up of many grains.

### Example 4

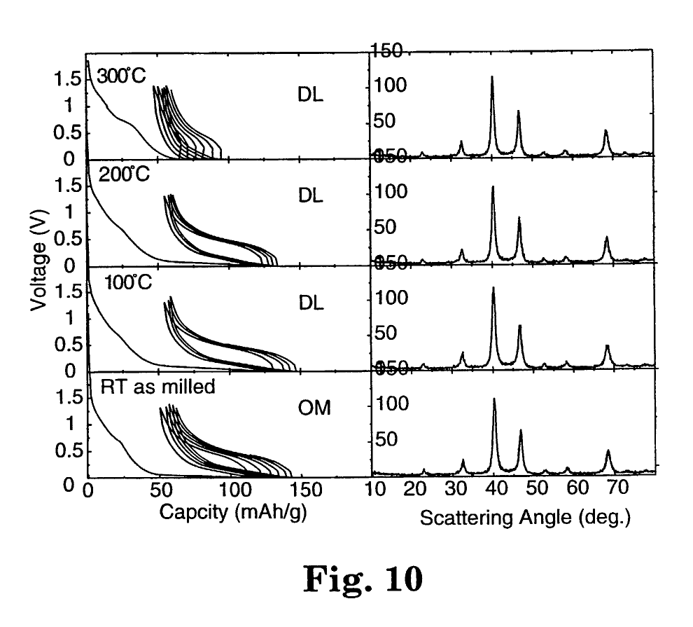

Six additional samples of SnFe₃C were prepared following the procedure of Example 2. The samples were heat-treated at 100° C., 200° C., 300° C., 400° C., 500° C., and 600° C., respectively, under vacuum for 3 hours. The x-ray diffraction spectra for these six samples, as well as the sample from Example 2 prepared without heat-treating, are shown in FIG. 10. As shown in FIG. 10, the widths of the Bragg peaks of the SnFe₃C phase narrow as the temperature increases, consistent with a growth of the size of the crystalline grains and a reduction in the number of atoms in the non-crystalline regions.

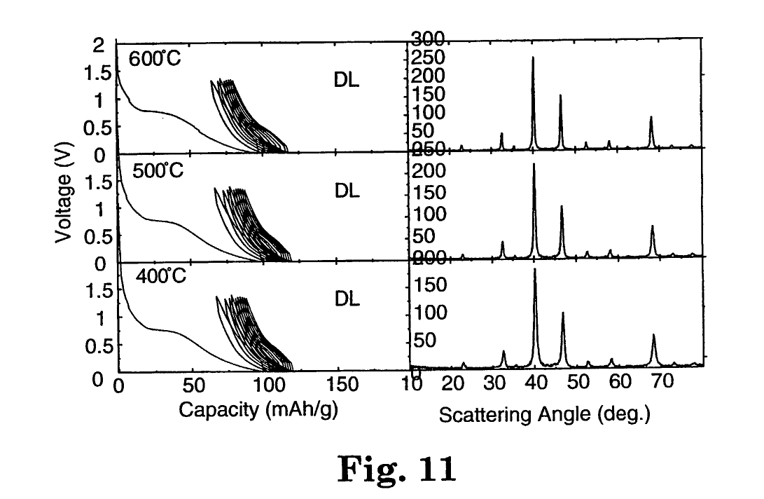

FIG. 11 shows the voltage versus capacity and capacity versus cycle number results for cells made from these samples. The cells containing heat-treated material show much smaller capacity compared to the cell containing unheat-treated material, of which about 15 mAh/g originates from the Super S carbon black used to prepare the electrode composition. These results are further evidence that heat treatment induces grain growth, thereby decreasing the width of the non-crystalline regions and reducing the reversible capacity of the materials. The reduction in capacity, in turn, is related to a decrease in the number of tin atoms in the non-crystalline regions available for reaction with lithium.

A number of embodiments of the invention have been described. Nevertheless, it will be understood that various modifications may be made without departing from the spirit and scope of the invention. Accordingly, other embodiments are within the scope of the following claims.

What is claimed is:

1. An electrode composition for a lithium ion battery comprising particles having a single chemical composition,
said particles consisting of (a) at least one metal element selected from the group consisting of tin, aluminum, silicon, antimony, lead, germanium, magnesium, zinc, cadmium, bismuth, and indium; (b) at least one metal element selected from the group consisting of manganese, molybdenum, niobium, tungsten, tantalum, iron, copper, titanium, vanadium, chromium, nickel, cobalt, zirconium, tantalum, scandium, yttrium, ruthenium, platinum, and rhenium; and, optionally, (c) carbon,
said particles having a microstructure characterized by a plurality of electrochemically inactive, nanometer-sized crystalline grains separated by electrochemically active non-crystalline regions.

2. An electrode composition according to claim 1 wherein said particles consist of (a) tin; (b) at least one metal element selected from the group consisting of manganese, molybdenum, niobium, tungsten, tantalum, iron, copper, titanium, vanadium, chromium, nickel, cobalt, zirconium, tantalum, scandium, yttrium, ruthenium, platinum, and rhenium; and, optionally, (c) carbon.

3. An electrode composition according to claim 1 wherein said particles consist of (a) at least one metal element selected from the group consisting of tin, aluminum, silicon, antimony, lead, germanium, magnesium, zinc, cadmium, bismuth, and indium; (b) iron; and, optionally, (c) carbon.

4. An electrode composition according to claim 1 wherein said particles consist of (a) at least one metal element selected from the group consisting of tin, aluminum, silicon, antimony, lead, germanium, magnesium, zinc, cadmium, bismuth, and indium; (b) manganese; and, optionally, (c) carbon.

5. An electrode composition according to claim 1 wherein said particles consist of tin, manganese, and carbon in the form of SnMn₃C.

6. An electrode composition according to claim 1 wherein said particles consist of tin, iron, and carbon in the form of SnFe₃C.

7. An electrode composition according to claim 1 wherein said particles range in size from about 2 microns to about 30 microns.

8. An electrode composition according to claim 1 wherein said crystalline grains are no greater than about 20 nanometers.

9. An electrode composition according to claim 1 wherein said non-crystalline regions represent at least 10% by volume of said particle calculated from transmission electron microscopy assuming spherical grains.

10. A lithium ion battery comprising:
(a) a first electrode comprising particles having a single chemical composition,
said particles consisting of (i) at least one metal element selected from the group consisting of tin, aluminum, silicon, antimony, lead, germanium, magnesium, zinc, cadmium, bismuth, and indium; (ii) at least one metal element selected from the group consisting of manganese, molybdenum, niobium, tungsten, tantalum, iron, copper, titanium, vanadium, chromium, nickel, cobalt, zirconium, tantalum, scandium, yttrium, ruthenium, platinum, and rhenium; and, optionally, (iii) carbon,
said particles having a microstructure characterized by a plurality of electrochemically inactive, nanometer-sized crystalline grains separated by electrochemically active non-crystalline regions;
(b) a counterelectrode; and
(c) an electrolyte separating said electrode and said counterelectrode.

11. A battery according to claim 10 wherein said particles consist of (a) tin; (b) at least one metal element selected from the group consisting of manganese, molybdenum, niobium, tungsten, tantalum, iron, copper, titanium, vanadium, chromium, nickel, cobalt, zirconium, tantalum, scandium, yttrium, ruthenium, platinum, and rhenium; and, optionally, (c) carbon.

12. A battery according to claim 10 wherein said particles consist of (a) at least one metal element selected from the group consisting of tin, aluminum, silicon, antimony, lead, germanium, magnesium, zinc, cadmium, bismuth, and indium; (b) iron; and, optionally, (c) carbon.

13. A battery according to claim 10 wherein said particles consist of (a) at least one metal element selected from the group consisting of tin, aluminum, silicon, antimony, lead, germanium, magnesium, zinc, cadmium, bismuth, and indium; (b) manganese; and, optionally, (c) carbon.

14. A battery according to claim 10 wherein said particles consist of tin, manganese, and carbon in the form of SnMn₃C.

15. A battery according to claim 10 wherein said particles consist of tin, iron, and carbon in the form of SnFe₃C.

16. A battery according to claim 10 wherein said particles range in size from about 2 microns to about 30 microns.

17. A battery according to claim 10 wherein said crystalline grains are no greater than about 20 nanometers.

18. A battery according to claim 10 wherein said non-crystalline regions represent at least 10% by volume of said particle.
